(19) United States
(12) Patent Application Publication
(10) Pub. No.: US 2025/0206084 A1
(43) Pub. Date: Jun. 26, 2025

(54) ARRANGEMENT TO MEASURE A TYRE PRESSURE

(71) Applicant: Teknologian tutkimuskeskus VTT Oy, Espoo (FI)

(72) Inventors: Arttu HUTTUNEN, Espoo (FI); Kimmo KERÄNEN, Espoo (FI)

(21) Appl. No.: 18/956,738

(22) Filed: Nov. 22, 2024

(30) Foreign Application Priority Data
Dec. 22, 2023 (FI) 20236429

(51) Int. Cl. B60C 23/04

(52) U.S. Cl. CPC B60C 23/0493; B60C 23/0433

(57) ABSTRACT

A tyre pressure arrangement according to the invention has a tyre pressure sensor (3) and a radio frequency communication device (5) and an identification part (6). The arrangement has also an electronic part (7) comprising said radio frequency communication device (5) and identification part (6), and a pressure sensor reading electronics (4). The electronic part (7) is arranged to be embedded to the rubber of a tyre (1), the tyre pressure sensor (3) being in connection with the electronic part (7) and arranged to be attached on the internal surface (9) of the tyre.

### FIELD OF TECHNOLOGY

The invention relates to arrangements to measure a tyre pressure, especially a pressure of a vehicle tyre.

### PRIOR ART

It is known to measure a pressure inside a vehicle tyre utilizing a pressure sensor. In order to communicate measured pressure data outside to a vehicles CPU or other unit, a wireless communication system, like a RFID (Radio Frequency Identification) system, is used.

A known pressure sensor module is either added to the valve of the tyre or embedded into the inner surface of the rubber. Anyway, the pressure sensor needs an access to the inner atmosphere of the tyre. Therefore, different cavity or pipe solutions exist. A separate identification tag may be embedded into the rubber.

Current solutions are relatively complicated and makes a manufacturing of a tyre even more challenging as it already is.

### SHORT DESCRIPTION

The object of the invention is to make an alternative solution in order to alleviate the problems of known embodiments. The object is achieved in a way described in the independent claims. Dependent claims illustrate different embodiments of the invention.

An arrangement to measure a tyre pressure according to the invention has a tyre pressure sensor and a radio frequency communication device and an identification part. The arrangement has also an electronic part comprising said radio frequency communication device and identification part, and also a pressure sensor reading electronics. The electronic part is arranged to be embedded to the rubber of a tyre, the tyre pressure sensor being in connection with the electronic part and arranged to be attached on the internal surface of the tyre.

### LIST OF FIGURES

In the following, the invention is described in more detail by reference to the enclosed drawings, where

FIG. 1 illustrates an example of an inventive arrangement.

### DESCRIPTION OF THE INVENTION

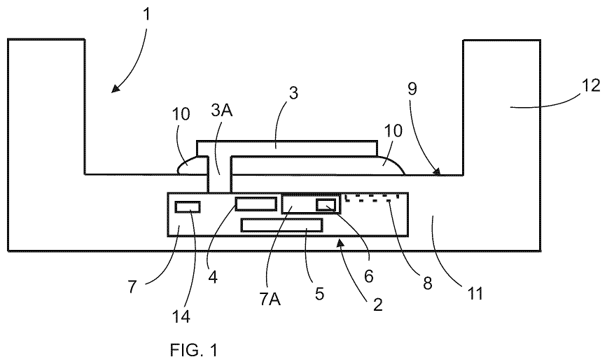

FIG. 1 illustrates a schematic example of the inventive arrangement. It shows a tyre 1 and the invention very schematically, not showing, for example, all elements of the tyre.

The arrangement to measure a tyre pressure according to the invention has a tyre pressure sensor 3 and a radio frequency communication device 5 and an identification part 6. The arrangement has also an electronic part 7 comprising said radio frequency communication device 5 and identification part 6, and also a pressure sensor reading electronics 4. The electronic part 7 is arranged to be embedded to a rubber of a tyre 1, the tyre pressure sensor 3 being in connection with the electronic part 7 and arranged to be attached on an internal surface 9 of the tyre.

Said radio frequency communication device 5, identification part 6, and the pressure sensor reading electronics 4 are embedded or integrated within the electronic part. The identification part is conveniently a data part in the memory 7A of the electronic part. Other possible elements can also be embedded or integrated within the electronic part 7.

Optionally the electronic part 7 may also comprise a temperature sensor 8. Utilizing temperature information, wearing of the tyre can be followed or predicted more accurately. The arrangement, i.e. the electronic part 7 and the pressure sensor 3 (having also the connection 3A to the electronic part 7) is an integral structure. The electronic part is arranged to be embedded into the rubber 11 of the tyre 1, in the example of FIG. 1, into the rubber of the tread. The pressure sensor 3, being an analog element, is arranged to be situated on the internal surface 9 of the tyre, where it is capable of measuring the tyre pressure in the space restricted by a rim (not shown in FIG. 1), and the tread 2 and the sidewalls 12 of the tyre 1. The tyre pressure sensor 3 is arranged to utilize a piezoresistive ink or a capacitive structure or another suitable technique.

As said, the tyre pressure sensor 3 is arranged to be attached on an internal surface 9 of the tyre. A suitable adhesive 10 can be used. A curing process may also be utilised for attaching the tyre pressure sensor when manufacturing the tyre 1.

The radio frequency communication device 5 and an identification part 6 can be made utilizing different techniques. The radio frequency communication device 5 communicates with, for example, a vehicle's CPU (Central Processing Unit) or another processing unit in the vehicle. The identification part 6 identifies the tyre 1.

In order to have power, the electronic part 7 comprises a power source or a wireless power coupling element 14. The power source can be a battery. The wireless coupling element can be formed using different techniques.

Because the invention has an integrated structure, a tyre manufacturing is not so complicated as in the prior art solutions, since only one structure is needed to be added into the tyre. In addition, there is no need to make cavity through the rubber of tyre for sensing the pressure of the tyre. The inventive structure is attached into the rubber of the tyre during manufacturing process, more specifically when curing the tyre (or a part of the tyre). If needed, adhesive may used in order to make sure that the pressure sensor is properly attached to the internal surface 9 of the tyre.

Since the electronic part 7 having the identification part 6 is embedded/integrated among the electronic part 7 in the rubber of the vehicle's tyre, it is hard to remove it from the tyre. Some people tend to remove the identification tags away from the tyres for instance due to security concerns or for counterfeit purposes. However, legislation may require to use the identification parts/tags so that the tyres can be monitored through their life time. The identification parts help also recycling processes. A separate identification tag is not needed in the inventive arrangement.

As said above, FIG. 1 is very schematic. The dimensions of the inventive arrangement are exaggerated and in real embodiment they are smaller and thinner, especially when comparing, for example, to tyre sizes of passenger cars. The electronic part 7 may also comprises other elements than described above.

It is evident from the above that the invention is not limited to the embodiments described in this text but can be implemented in many other different embodiments within the scope of the independent claims.

1. An arrangement to measure a tyre pressure having a tyre pressure sensor and a radio frequency communication device and an identification part, wherein the arrangement has an electronic part comprising said radio frequency communication device and identification part, and also a pressure sensor reading electronics, the electronic part being arranged to be embedded to a rubber of a tyre, the tyre pressure sensor being in connection with the electronic part and arranged to be attached on an internal surface of the tyre.

2. The arrangement according to claim 1, wherein the electronic part comprises also a temperature sensor.

3. The arrangement according to claim 1, wherein the electronic part comprises a power source, being a battery or a wireless power coupling element.

4. The arrangement according to claim 1, wherein the tyre pressure sensor is arranged to utilize a piezoresistive ink or a capacitive structure.

5. The arrangement according to claim 1, wherein the arrangement is an integral structure.

6. The arrangement according to claim 5, wherein the identification part is integrated with the electronic part.
